(19) United States
(12) Patent Application Publication
(10) Pub. No.: US 2007/0151593 A1
(43) Pub. Date: Jul. 5, 2007

(54) Solar powered survival suit

(75) Inventor: Steven Alden Jaynes, Morro Bay, CA (US)

Correspondence Address: Steven A. Jaynes, 2880 Ironwood Avenue, Morro Bay, CA, 93442, US

(73) Assignee: Steven Alden Jaynes, Morro Bay, CA (US)

(21) Appl. No.: 11/607,911

(22) Filed: Nov. 30, 2006

(51) Int. Cl. H02N 6/00

(52) U.S. Cl. 136/244; 136/291

(57) ABSTRACT

An industrial application whereby flexible thin film solar cells and/or flexible thin film solar panels are attached to fabric(s) using stitching, gluing, laminating, to yield a durable, moldable, portable, vehicle for supplying electrical energy. This hybrid fabric can then be used to construct other useful applications where solar power has previously not been able to attend in a useable fashion. In particular, the construction of a light weight solar powered survival suit. This garment consists of a hood, jacket, and pants that are embossed by thin film solar panels and/or individual thin film solar cells. The suit further includes at least one 12-volt port capable of powering electrical devices used for survival.

### TECHNICAL FIELD OF THE INVENTION

The present invention relates to solar energy use and the field of survival garment manufacture. In particular, the field of thin film solar panels and solar electrical material(s), and the combination of such to and with garments used for the well being and survival of mammals. The hybrid fabric produced to manufacture said garments, and the benefit of this product to life.

### BACKGROUND OF THE INVENTION

The need for a self sufficient energy source on long hiking, mountaineering expeditions, sailing trips, electric cars, even space expeditions, has long been in need of. Only in recent years have the tools to achieve this goal been realized. The field of science has now brought solar energy to the current state of being not only portable, but lightweight and flexible (i.e. Simburger, et al). The state of material manufacturing has brought the art to a level providing such products such as Gortex, Ultrex, Sunbrella, and Kartex. The problem with conventionally available thin film solar cells and panels is that although they can be rolled up, then transported somewhere, they must then be physically unrolled, positioned in some fashion to face the sun, then repositioned as the Sun continually changes position. The invention hereby disclosed, solves many of these problems. Worn as an external garment this solar powered survival suit, using the solar embossed fabric described above, allows the human body the ability to at will, or passively position the solar embossed portion of the solar powered fabric (external side) towards areas of high solar exposure. This electrical current can then directly empower; warming device(s), cooling device(s), electrical storage devices (such as lithium ion batteries), communications equipment, or other equipment requiring portable electricity. This mobility gives hope to potentially prevent hypothermia and frostbite, or hyperthermia, when used in conjunction with this invention. The former being the motivation in my initial experimentations with prototypes, now here formally disclosed. From the personal experience of being stranded on the side of a cold mountain, alone, left to die, it dawned on me how this invention could save lives. A further extension to collegues who venture into extremely hot environments, could be adapted to power cooling apparatus. For the urban user, a garment for powering computers, I-pods, etc. is yet a further adaptation of the solar powered survival suit in a social sense.

### SUMMARY OF THE INVENTION

An object of the invention is provided to form a flexible, moldable, fashionable, portable vehicle whereby thin film solar cells and thin film solar panel technology can be combined to fabric, thus creating a substrate from which the solar powered survival suit can be made, has hereby been disclosed.

According to one aspect of the invention, its use in outdoor settings, such as high elevation expeditions, where cold, often harsh environments predominate, to desert conditions, where hot, humanly hostile heat abounds, or other outings to where the mammalian user is exposed to elements that are harmful to physiologic function, this self contained garment, providing the means whereby homeostasis may be maintained, is ideal in that it provides electrical power, independent of conventionally supplied electricity. It solves the problem of carrying excessively heavy weight, such as battery packs, excessive clothing, clothing insulation, by supplying the means to directly heat or cool the body. Conversely, to charge lightweight rechargeable cells, that may be used during times of no or minimal solar exposure.

Another object of the invention is to provide multiple users of the solar powered survival suit the ability to connect, via an extension cable, such that multiple suits may be connected either in series or in parrallel by electrical standards. This enables multiple users to achieve feats that are greater than the sum of one.

According to another aspect of the invention, its use in urban settings provides its users the capacity to power conventional electronic devices such as computers, cell phones, CD and DVD players, radios for extended periods of time. In these settings, as well as others, it provides “clean energy”, with no environmentally harmful emissions. As our planet becomes ever so much more populated, the need for such clean energy is inevitable. Here, the name “Solar Powered Survival Suit” truly contributes to lifes survival.

Another object of this invention is to provide portable electrical energy to patients dependent on electrical energy to power life sustaining equipment, such as pacemakers, respirators, insulin pumps, and portable dialysis equipment the ability to travel beyond their range of urban power systems. In fact, the hope of seeing the great outdoors, that before now, were unreachable.

### BRIEF DESCRIPTION OF THE DRAWINGS

FIG. 1 illustrates the front and back over all view of the solar powered survival suit.

FIG. 2 illustrates a detailed view of the front of the solar powered survival suit. shows a hooded jacket, pants with the thin film solar panels as squares and various geometric shapes, further discussed in detailed description of drawings.

FIG. 3 illustrates a detailed view of the back of the solar powered survival suit. It shows a hood jacket, pants with the thin film solar panels as squares and various geometric shapes, further discussed in detailed description of drawings.

FIG. 4 illustrates a detailed top view of a segment of fabric embossed with three thin film solar panels connected in series, further discussed in detailed descriptions of drawings. It also illustrates an exploded side view, showing depth and layers.

FIG. 5 illustrates the schematic diagram of how the thin film solar panels connect together electrically. In general, most of all the electrical wiring in between panels is adhered to the inner felt lining with a fabric quality, glue gun adhesive.

FIG. 6 illustrates the parts of a basic fabric pattern that would enable a seemstress to lay out the individual pieces embossed with thin film solar panels and assemble the solar powered survival suit.

### DETAILED DESCRIPTION OF THE DRAWINGS

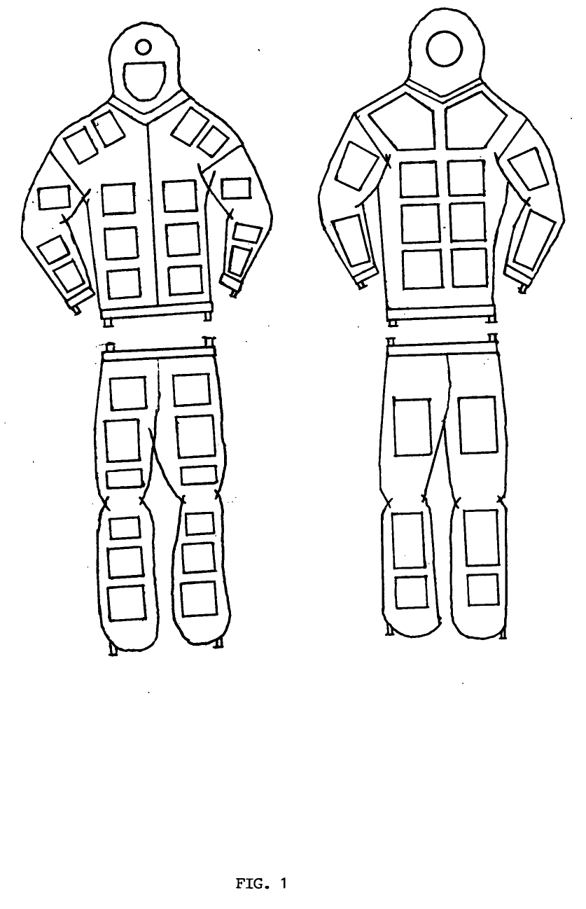

Many advantages of the invention are illustrated in FIGS. 1-6 and show a way whereby a garment embossed by thin film solar panels and thin film solar cells (for simplicity, hereby referred to as tfsps' or tfscs' respectively) can provide its mammalian user a means of obtaining electrical energy for survival. In one form, this electrical energy derived from its solar source, can be used to power electrical heating elements to keep its user free from frostbite and the morbidity of extended exposure to extreme cold environments. In yet another form, it provides the means whereby batteries may be charged for the use of heating its user during nightime or periods of low solar availability. Ultimately, this garment provides a mobile, wearable, moveable, extendable, method whereby electric energy is derived from a source that is neither terrestial or derived from conventional sources of electrical power. A further extension of this portable power garment is in its use to power an apparatus whereby its user is kept cool, thus preventing heat stroke and morbidity from extremely hot environments. One such apparatus could be that of pumping coolant around the users body. In an urban environment, the use of this portable electrical source could be used to power such devices such as gps navigational systems, computers or computing devices, radios, cell phones, cd/dvd players, power tools, lighting systems just to name a few. In all enabling its user to have continual power that is environmentally friendly.

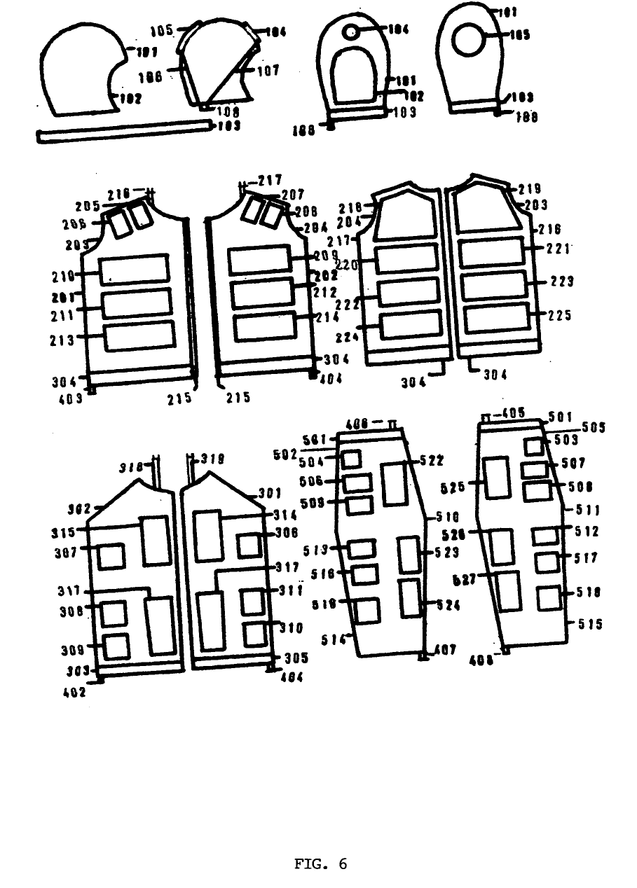

In particular, this invention is expressed and disclosed as a solar powered survival suit. It is a garment consisting of, but not limited to a hooded jacket, and pants. Each capable of generating solar derived electrical energy and providing it in combination or independently of each of its parts. In particular, if the energy from the jacket was sufficient for its users needs, the hood may be removed or simply turned off. This also applys to the pants portion of the suit. This invention also allows for at least three 12-volt capable electrical ports, whereby the garment could be coupled to other solar powered survival suits, or suit parts to give multiplication to the amount of potential energy desired. Disclosed here, in its most simple form, the suit is comprised of a basic material such as Gortex, that is embossed by sewing on prefabricated thin film solar cell arrangements, then laminated over the parameters of these individual arrangements, to provide water resistance. This fabric is then simply lined by a fleece inner side, with the matrix of electrical leads shown in FIG. 6 combined and channeled to the 12-volt electrical leads.

A simple paper pattern for a hooded jacket and pants is followed in the cutting and attachment of its individual pieces to complete this invention. This model is presented in this simple format such that further augmentation by industrial manufacturing would be at its easiest starting point. Thus, further insulation, or addition of heating or cooling elements could be carried out by other manufacturing techniques, with this solar powered survival suit serving as a vechicle for solar supplied electrical energy.

Thin film solar panels and thin film solar cells, may be used interchangeably throughout the detailed description of this invention. Custom shapes and designs of this technology are made available by several companys currently in operation. Power Film, First Solar, Iowa Thin Film Technology at time of this application are the industries leaders. These manufactures produce several arrays that yield a range of voltage and current capacities. Anywhere from 1.2 to 12 volts, and 2.2 watts to at least 300 watts are achievable with their products. As the invention here employs several distinct shapes and sizes, the output in general may range between the above parameters, the working model utilized the 12 volt (+/−0.3 volts), 35-62 watts of output during peak solar activity.

FIG. 1 illustrates a basic front and back view of a solar powered survival suit comprised of a hooded jacket with pants. The squares, rectangles, circles, and multi-lateral shapes drawn on the exterior portion of the garment represent the thin film solar cell portion of the garment. It also depicts an opening on the front of the hood for exposure of the face. The circular line between the hood and the jacket is the area of attachment. It can be sewn on or otherwise attached by such a material as Velcro for easy removal. Also depicted in the middle of the front of the jacket is the area whereby the left and right side of the garment is attached allowing it user to put on the jacket and open or close it accordingly. In most applications this would be where the zipper is located. The invention however allows for such attachments as Velcro or other self adhesive material to be used as the art of garment manufacturing evolves. At the bottom of the jacket is a waste band. It may be fixed or flexible using spandex or other elastic material. Both front and back views show a 12-volt capable plug at the cuff on both the right and left arm of the jacket. This 12-volt plug is capable of handling the current supplied to it in the above stated current ranges. It is intended to power, but not limited to, electrically heated gloves, available from many manufactures. The bottom of the jacket also shows a third 12-volt plug, at right from the frontal view, and reversed on the left, of the rear view. This 12-volt plug is provided for a teathering electrical cord to allow the jacket to be connected to another solar powered survival suit or conversely used to power external electrical equipment. At the bottom of the jacket, at the left side of the frontal view and reversed right, of the rear view is shown a fourth 12-volt plug. This plug is intended to couple the electrical portion of the hooded jacket to the electrical portion of the pants of this invention.

At the top of the pants is shown a waste band. It may be fixed or flexible using spandex or other elastic material. On the left side of the frontal view, and in reverse on the right side of the rear view, a fifth 12-volt plug is shown. This plug is provided for a tethering electrical cord to allow the pant portion of the suit to be connected to another solar powered survival suit, or conversely to power other electrical devices. On the right side of the frontal view, and in reverse on the left side of the rear view, a sixth 12-volt plug is depicted. It is used to attach the hooded jacket electrical portion of the suit to the electrical portion of the pants. At the bottom of the right pant leg is shown a seventh 12-volt plug. It is intended, but not limited to, power electrically heated socks, boots, or shoes. At the bottom of the left leg of the pants is shown an eighth 12-volt plug. It is intended, but not limited to, power electrically heated socks, boots or shoes.

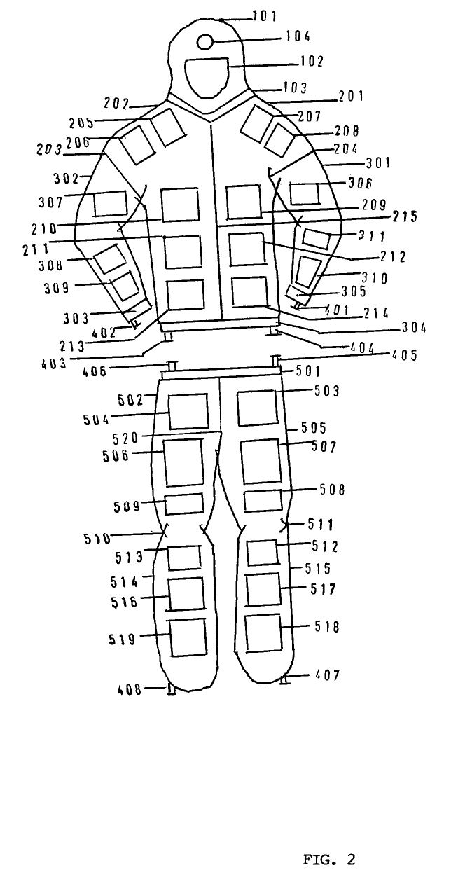

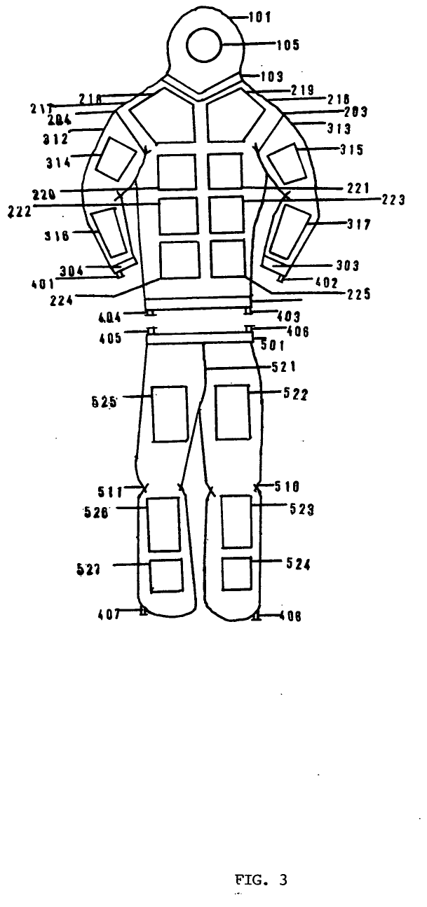

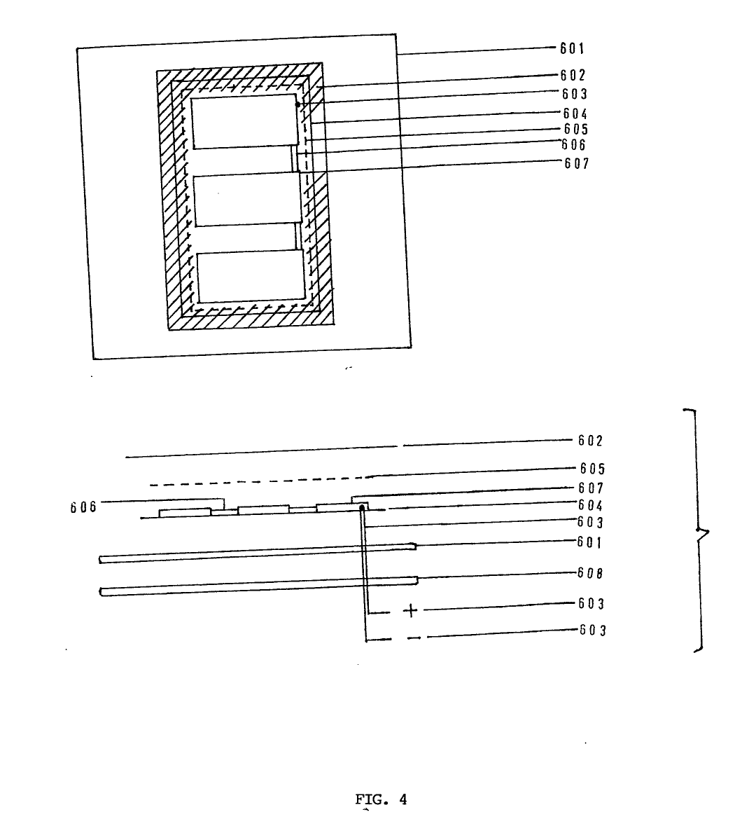

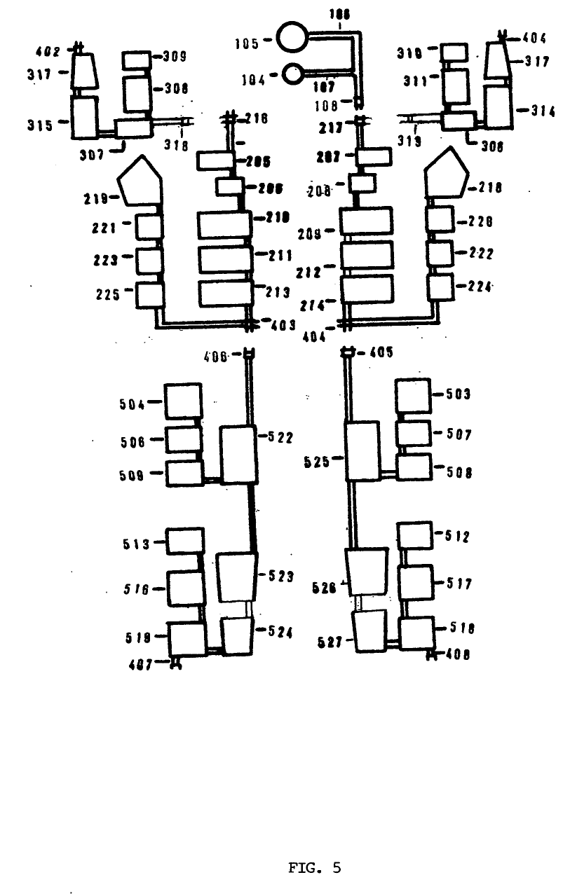

FIG. 2 illustrates a more indepth frontal view of the solar powered survival suit. FIG. 2 and FIG. 3 are included for sake of identifying the individual pieces by describing where and in what shape the final working product ended up taking shape. Although quite monotonous in description, it identifies to the where and what it is, versus functionality which is addressed more in the description of FIG. 4 and FIG. 5. Beginning at the top is 101 which is the fabric hood that is ebossed by the frontal solar panel 104. Subject 102 portrays the facial opening of the cap, much like that of many ski hoods. Subject 103 is the colar, connecting hood to the body of the jacket. It was simply fabric, with Velcro glued to the jacket and the hood in the final working model. 201 and 202 are simply the upper shoulder portions of the jacket, left and right respectively. Subjects 205, 206 then 207, 208 are the upper shoulder tfsc's are located. Subjects 203 and 204 are the points of connection for the left and right sleeves to the main body of the jacket. In my working model they were sewn on using a simple double stitch with nylon thread. They too however could easily be connected by Velcro, the same way the hood and body of the jacket were attached. This could yield a cooler version of the jacket, where the electricity is being used for something other that heating or cooling. This could also be used as an independent panel layed out flat with exposing side to the sun. Subjects 301 and 302 are the upper portion of the left and right sleeves respectively. Subjects 307 and 308 are the tfscs' of the upper sleeve. Subjects 209 and 210 are the upper, left and right tfscs' of the upper chest. Subject 211 is the right, front, middle tfsc. Subject 215 is the adjoinment of the left and the right side of the left and the front of the jacket. In the final working model, it is a zipper. Again, it could be replaced by Velcro for quick attachment and deattachment. Subjects 308 and 311 are the middle sleeve tfscs'. Subject 212 is the middle, front, left tfsc. Subjects 309 and 310 are the lower tfscs' of the right and the left sleeves respectively. Subjects 303 and 305 are the right and left cuffs of the sleeve respectively. Subjects 402 and 401 are the right and left sleeve 12-volt plugs respectively. Subjects 213 and 214 are the right, lower, and the left, lower tfscs' of the main body of the jacket. Subject 304, shown in further Figures, is the jackets waist band. Subjects 403 and 404 are the right and left jacket 12-volt plugs respectively. Subjects 406 and 405 are the right and left 12-volt plugs of the pants respectively. Subject 501 is the waist band of the pants. Subject 502 is the upper portion of the right pant leg. Subject 503 is the upper, front, left pant leg tftc. Subject 504 is the upper, front, right pant leg tftc. Subject 520 is the front seam of the right and left pant leg.

In the final working model it was simply sewn, using a double sewing machine stitch, as the waist was elastic. It could be replaced by a zipper or Velcro for easy attachment or disattachment. Subjects 506, 507, 508 and 509 are the remaining tfscs' of the upper portion of the pants. Subjects 510 and 511 shows the right and left knee creases respectively. Subjects 512 and 513 are the left and right, upper tfscs's starting below the knee creases 510 and 511. Subjects 514 and 515 are the lower portion of the right and left portion of the right and left pant legs respectively. Subjects 516, 517, 518, and 519 are the middle and lower tfsc's of the lower right and left pant legs. Subjects 407 and 408 are the left and right 12 volt plugs that extend out from the inside of the bottoms of the left and the right pant legs.

FIG. 3 shows a more indepth view of the back of the solar powered survival suit. Subject 101 is the rear view of the hood. Subject 105 is a large circular solar panel, that in the working model was 5½ inches in diameter. Subject 103 is the colar of the suit. Subjects 218 and 219 are the pentagonal shaped tftcs' of the right and left, rear shoulder view of the body of the jacket respectively. Subjects 216 and 217 are the rear points of attachment for the jacket to the sleeves of the suit. Subjects 312 and 313 are the rear view of the left and right portions of the sleeves respectively. Subjects 314 and 315 are the upper right and left tfscs' respectively. Subjects 220 and 221 are the rear view of the upper, right and left tfscs' of the body of the jacket. Subjects 222 and 223 are the middle tfscs' of the body of the jacket. Subjects 316 and 317 are the lower left and right sleeve tfscs' respectively. Subjects 303 and 304 are the cuffs of the sleeve from the rear view. Subjects 401 and 402 are the 12-volt plugs of the left and right sleeves respectively. Subjects 224 and 225 are the lowest, body section tfscs' of the left and right side of the jacket respectively. Subject 304 is the waist band of the jacket, shown from the rear view. Subjects 403 and 404 are the right and left 12-volt plugs of the jacket. Subjects 405 and 406 are the left and right 12-volt plugs extending from inside the top waist band of the pants. Subject 501 is the waist of the pants. In the working model it was made of simple elastic, encompassed by fabric sewn lewsly for ease of fit. Subject 521 is the rear seam of the pants, connecting the right side to the left side. In the working model, it was simply sewn as a double stitch using a conventional sewing machine. Subjects 525 and 522 are the upper tfscs' located on the back of the pants, approximately 7 inches from the bottom of the waist. This allows the user to sit down without wearing on these strategically placed tfscs'. Subjects 511 and 516 are the rear view of the knee crease in the pants. Subjects 523, 524, 526, and 527 are the lower right and left tfscs on the back of the pant legs. Subjects 407 and 408 are the rear view of the left and right 12-volt plugs that extend from the inside legs to the bottom of the left and right pant legs. No cuff was employed in the working model, as varied diameters of the pants bottoms are allowed to fit various sizes and shapes of boots, shoes and even styles.

FIG. 4 illustrates how a factory supplied row of 3 tfscs' in series are incorporated into the fabric of the solar powered survival suit, thus forming the basis of this new invention.

Thin film solar cells have traditionally been square and come mounted on a vinyl or other plastic backing. The above mentioned companies will supply a broadening industry with thin film solar cells in various geometric shapes, and with little or no backing to comply with this design. Three rectangular shaped thin film solar cells are shown here for sake of simplicity, and an exploded side view to show how the electrical leads go through the layers of fabric into the interior side of the solar powered survival suit. Subject 601 is the basic water resistant material. This material could be Gortex, Suprex, Ultrex, or even water resistant treated cotton. In the working model, Double Ripstop Gortex was used. Subject 602, shown by hatched lines is the lamination that covers the parameter of the factory supplied 3 solar cell unit. This lamination is a latex based plastic, available at most fabric stores. Once the tfscs' are sewn onto the material this laminated stripping is cut to cover over the sewing line (subject 605) and onto the fabric. It is then heated by an iron until it is able to have the backing pulled off and leave the lamenent on the fabric and tfsc. The backing is then discarded. Subject 603 is a top view of the two leads coming off the tfscs' that are electrically connected in series. These two leads penentrate through all layers of material, then lay paralell and flush with the felt lining of suit. Though shown as the two individual wires, they are actually bundled by a black plastic coating, which provides water, shock, and wear resistance. Subject 604 is the edge of the plastic on which the factory supplied tfsc's are laminated to. It is through this lining the seemstress sews the fabrication to the material of which the solar powered survival suit is made of. Subject 605 is the stitching that is used to attach the factory supplied solar cells to the fabric. As mentioned above, it is sewn into the plastic parameter that surrounds the factory supplied cell(s). The thread used in the working model was a water resistant nylon type. Subject 606 is the two leads that connect this examples 3 cell layout, electrically in series. Subject 607 is the actual thin film solar cell. It is shown as the middle cell in this 3 cell example. This 3 cell example is hereby used because it exemplifies the way the suits 3 cell front and 3 cell back, adorns both left and right sides on the body of the suit.

The exploded version follows all of the same numbering as the top view. Subject 602 is the lamination used to cover the sewing line. Subject 605 is the thread. Subject 607 is one of the tfscs'. Subject 604 is the plastic parameter on which the factory supplied cells come on, and is where the seemstress must sew to attach the solar array to the desired fabric. Subject 603 is the two electrical leads that penetrate down through the plastic layer (subject 604) then through the fabric (subject 601) then through subject 608, which is a felt lining that is adhered to the chosen fabric by a silicone based adhesive. Subject 601 is the desired outer fabric. As stated above, Double Ripstop Gortex was used in the final working model. Subject 608 is the above mentioned felt lining. Prior to sewing on any tfscs', all of the starting fabric is treated with a silicone based glue, to which a layer of ¼ inch thick felt is adhered to. This starting fabric allows for the interior lining to become the platform for which the interior wiring of all tfscs' to each other, be glued down to. In other words, once the leads from all tfscs' penetrate the fabrics, they are soldered to 25 gauge electrical wiring, then wrapped by 2 wraps of electrical tape, then glued down to the felt interior using a glue gun. This simple construction could be further augmented by adding a third material lining over the felt-electrical array. If the desired use is warmth, further augmentation of an insulate material could be added.

If the desired use is cooling then a thin mesh material may be added. It is the main intent of this invention to supply a survival suit whereby thin film solar technology has a basic platform for which to start from, supplying mobile electrical energy. As previously stated, its use in an urban setting for supplying electricity for I-pods, computers, cd/dvd players, navigational tools, etc. allows for the addition to the interior of any material to make its user comfortable.

FIG. 5 is the electrical schematic diagram from which the interior wiring is followed. Double lines between the individual tfscs' and thin film solar panels are equivalent to any solid lines. The solid lines are included to show that the individual + and − wires are actually wires. In the longer stretches like the ones that extends more physically distant cells or groups of cells, a heavier gauge wire may be desired. For example, in between the lower leg grouping of cells (subjects 513, 516, 519, 524, and 523) up to the upper leg grouping (subjects 504, 506, 509 and 522) an 18 or even 16 gauge wire may be desired. In the working model the 25 gauge wire was quite functional, yet did generate significant heat. Starting at the top of the page, subject 402 is the right arms 12-volt electrical plug at the end of the cuff. Its primary use is to supply electrically heated gloves with electrical energy for heating, thus potentially ending frostbite. Subjects 317, 315, 307, 308 and 309 are the tfscs' of the right sleeve. Subject 318 is an internal plug that connects the sleeve to the body of the jacket (via subject 216, the body of the jackets 12-volt plug). This design was chosen such that if the need arises for detaching the sleeve for a stand alone array of panels, it could be. Moving down the left side of the schematic (actually the right side of the suit) subjects 219, 221, 223, 225 are the right, back tfscs'. They are electrically connected to the front, right sided tfscs', subjects 205, 206, 210, 211 and 213. Above subject 205 is subject 216 is the 12-volt plug that connects to subject 318, the 12 volt plug connecting the right sleeve to the jackets body. Below subject 213 is subject 403, a 2 way 12-volt plug that may be attached to subject 406, the 12-volt plug that connects the tfscs' of the pants, OR may be used to teather the solar powered survival suit to another user, or an alternative electrical need. As this also holds true for the lefts sides 12-volt plug, subject 404, it will not be repeated in the discussion of its use. Continuing down the left side of the schematic (the right side of the pants circuit) is subject 406, a 12-volt plug that may be connected to the jackets 12-volt plug (subject 403) or used to supply the above mentioned alternative uses. Subjects 504, 506, 509 and 522 are the tfscs' of the upper right pant leg. Subjects 513, 516, 519, 524 and 523 are the front and back tfscs' of the lower leg. Below subject 519 is subject 407, a 12-volt plug. The primary use of this plug is to supply electrical energy to boots, or shoes. In this application, used to power electrically heated socks, thus potentially preventing frostbite to the feet. Returning to the top of the page, subject 105 and subject 104 are the hoods back and front circular solar panels. Subjects 106 and 107 are the wires that connect to subject 108, a 12-volt plug that connects to subject 217, the two-way 12-volt plug that connects the hood to the jacket, also the left sleeve to the jackets body. Subjects 106 and 107 were included for describing how to glue down the wires, for aid to the seemstress (pattern assembly is discussed in the desription of FIG. 6) To the immediate right of the hood schematic is the left sleeve schematic.

It follows the same pattern of the right sleeves schematic. Subjects 310, 311, 306, 314 and 317 are the tfscs' of the left sleeve. Subject 404 is a 12-volt plug. Again, its primary use is to supply power to electrically heated gloves, but is not limited to that use. Subject 319 is a 12-volt plug that connects to subject 217, a 2 way 12-volt plug. This connects the left sleeve to the body of the jackets circuitry. As with the right sleeve, it could also be used to power other electrical devices, should the user detach the sleeve from the jacket. Beginning with subject 217, a 2 way 12-volt electrical plug, subjects 207, 208, 212, 214, and subjects 218, 220, 222, and 224 are the jackets front and back tfscs' of the left, front and back respectively. Located below tfscs subject 214, is subject 404 a 2 way 12-volt plug. It may be used to connect the circuitry of the jacket to the pants, or used to teather other devices powered by electrical energy. Moving down the schematic to subject 405, a 2 way 12-volt plug which may be used to connect the pants circuitry to the hood, jacket, right side of the pants circuitry, or used to teather to another device powered by electrical energy. Following the mirror immage of the right sided circuitry is subjects 525, 508, 507, 503 and subjects 526, 527, 518, 517 and 512 are the upper and lower, left legs tfscs'. Below subject 518 is subject 408, a 2 way 12-volt plug. Its primary use is to power electrically heated socks to prevent frostbite. It may also be used to teather the pants circuitry to other electric devices.

FIG. 6 illustrates the most basic of patterns that lends the seamstress the ability to assemble the solar powered survival suit. The first step in the construction begins with prepping the material. This involves laying out a sufficient quantity of exterior material to complete the construction of the solar powered survival suit. According to most paper patterns available in most fabric stores, this is about 3-4 yards of material, depending on the size of the individual it is built for, either small, medium, large or extra large. The material is then ironed out to render it free from wrinkles, crimps, and free from manufacturing defects. A ¼″ thick felt lining is glued to the backing of the desired material using a silicone based adhesive, available at most fabric stores. Using a cut out paper pattern for a hooded ski suit and following its instructions will yield the construction portion of the invention with the following provisions. The thin filmed solar cell panels, and thin film solar cells (tfscs') are attached, electric leads inserted through the layers, electric schematic followed (FIG. 6) on the interior felt layer(s), of the individual pieces of the suit. Beginning at the top of the page is subject 101, a single piece of felt lined fabric cut out in the figure of a side view of the hood. In the working model it was felt lined Double Ripstop Gortex. It is cut as shown times two, to create the left and right side of the hood. These two pieces are sewn together to create the hood. Subject 102 is the side view of the facial opening. Subject 103 is the colar, which is attached to the hood after the tfscs' are attached. Subject 105 is the rear solar panel. Subject 104 is the frontal solar panel. Subject 106 is the wiring from the rear solar panel (subject 105). Subject 107 is the wiring from the frontal solar panel (subject 104). Both wires are glued down to the felt interior of the hood and attach to subject 108, a 2 way 12-volt plug that connects the hood to the jacket.

The seamstress is to hole punch an approximate 1/128″ hole for the lead wire from each of the solar panels, as well as is done with all the tfscs', through the outer gortex layer, through the felt layer, then glue down the leads to the felt lining. The wires are then connected to subject 108 electricaly using standard + and − leads. Subject 108 extends down to just below the collar, subject 103. It is sewn in place to secure it to right side of the colar. Moving to the right, shown is a frontal and rear view of the finished hood. Below the initial hood drawing are the front, right patterned view of the jackets body. To its immediate right is the front, left patterned view of the jackets body. All subjects are the same as in the detailed description of the frontal view (FIG. 2) and all contain 2 way 12-volt plugs as are shown in the schematic (FIG. 5). Subject 215 is the point of attachment of the left front, and the right front parts of the jackets body. In the working model this is a zipper. It could be made of Velcro for quick disassembly and ease of use. The seamstress is to follow all points born out in the detailed desription of sewing on the tfsc's and thin film solar panels when attaching them to the pattern shown here. Note that subject 216 is a 2 way 12-volt plug that connects the sleeve to the jackets body. It must be sewn in place leaving enough slack on the wiring such that it may reach the collar area. It is shown here in the collar area, but most often will be used to simply connect the circuitry from the right sleeve to the where it is jackets body. To the immediate right of the front, right and the front, left patterns are the left, back and the right, back patterns. The seamstress is to sew the leading edge of the front, left panel (subject 202) to the leading edge of the back, left panel (subject 217) using an overlock stitch. Likewise, the front, right pannel (subject 201) is to be sewn to the leading edge of back, right panel (subject 216). Subject 304 is the waist band of the jacket. It is to be sewn on as the next step, in a likewise manner to which the collar was attached to the hood. Following the most basic patterns, this completes the basic assembly of the jackets body. The seemstress is to assure that subjects 216, 217, 403 and 404 are secured to the jackets body, leaving enough slack to allow them to serve as teathering lines when needed. The far lower left drawing is a diagram of the left and right sleeve. Subjects 318 and 319 are the 2 way 12-volt plugs that connect the sleeves tfscs' circuitry to the circuitry of the rest of the jackets body. Subjects 402 and 404 are the 2 way 12-volt plugs at the ends of the sleeves. They are to be secured to distal side of the sleeves wrist area. This is to allow electrical current supplied by the tfscs' to power electrically heated gloves, thus potentially eliminating frostbite. Subject 302 is the right sleeve. Suject 301 is the left sleeve. Once the tfscs' are secured, in its most simple form they are wrapped in a tube shape, forming the sleeve. The last drawing is the right and left leg of the solar powered survival suit. Subject 502 is the right leg of the pants. Subject 505 is the left leg of the pants. Once formed in a tube shape, they are sewn using the standard sewing machine to form the legs. They are then sewn down the front, then down the back. This forms the most basic structure of pants. Subject 501 is the waist band, which is added afterwards. The seamstress is to secure subjects 405 and 406, the 2 way 12-volt plugs to the lateral sides of the pants waist band. They should be aligned such that they may be easily connected to subjects 403 and 404, the 2 way 12-volt plugs of the suits jacket. Subjects 407 and 408 are the 2 way 12-volt plugs of the pants.

They are to be secured to the bottom of the pants in a way that allows them to be connected to electrically heated socks, thus potentially eliminating frostbite. This concludes the fabrication portion of the suit. It should be stated that although this follows the most rudimentary fabric pattern, it does not negate its use on more elaborate tailoring. Indeed, in most applications it will be used in the highest level of garment construction available to the most skilled craftsman. In future or urban settings, the tfscs' shown here may actually become the entire, integrated surface of the garment. In other words, instead of being individual cell panels and thin film solar cells, the garments exterior could be made entirely out of thin film solar material. Lightweight, durable, versatile, and even stylish in fashion.

What is claimed is:

1. A method of manufacturing a solar powered survival suit, unique in that it is created from material that has been embossed by thin film solar paneling and thin film solar cell technology. This fabric can be fashioned to create shapes and sizes used in the construction of this suit, adaptable for multiple applications, in particular the manufacturing of a garment to protect man and other animals alive and well in harsh environments. The suit consists of an external portion and an internal portion. The external portion being that part embossed by the thin film solar technology. The interior being the part of the garment that is closest to the body. The electricity generated from the external portion of the suit is conglomerate in collecting solar energy that when converted into electrical energy, is then channeled to at least one twelve-volt electrical port. This electrical energy may be used to charge storage devices such as batteries, or directly power heating or cooling devices, or power other electrical instruments such as computers, navigational equipment, I-pods as just a few examples.

2. The method of manufacture of claim 1 wherein, the step of laying out a portion of fabric on a conventional workspace such as an ironing board, work bench or other large tabled area and ironing out any crimps, creases or other deformities in the supplied bulk material leaving it in good form to be sewn, hemmed, glued, adhered to, overlayed on, in seemstress terms “prepped”.

3. The method of manufacture of claim 1 wherein, a segment of thin film solar cell or thin film solar paneling is then positioned on portions of the fabric that will be exposed to the sun, henceforth termed the “external side of the fabric”. The term “internal side of the fabric” is used for the side(s) NOT exposed to direct sunlight.

4. The method of manufacture of claim 1 wherein, the thin film solar cell or thin film solar paneling is then sewn, glued, overlayed with adhesive, laminated, or other wise attached to the external side of the fabric, by hand or with conventional machineries using cotton or synthetic thread, epoxy glue(s), plastic adhesive film(s), heat processes, or other adherents that make the thin film solar cell or thin film solar paneling become securely attached to the desired fabric.

5. The method of manufacture of claim 1 wherein, the original fabric being selectively embossed with thin film solar panels and thin film solar cells, a felt backing is glued to it creating a suitable surface henceforth termed the “internal side of the fabric”.

6. The method of manufacture of claim 1 wherein, the solar powered fabric may then be fashioned such that the solar cell array or solar panel material exterior may be interrupted by areas of fabric that are NOT covered by solar cell or solar paneling, allowing for movement of the fabric without interuption of the electrical processes produced by the thin film solar technology.

7. The method of manufacture of claim 6 wherein, this non-covered area may then be cut, bent, creased, sewn on, molded into other shapes to allow for maximal solar exposure, used to connect the material to itself, to other material(s), energy reservoirs, or other devices that operate from electrical current, without interrupting electrical conductivity.

8. The method of manufacture of claim 1 wherein, the summation of the electrical energy gathered by the surface area of the solar powered survival suit is channeled via micro fine 16-25 gauge enamel coated wire(s), or otherwise current protective coated wiring, to the interior of the suit. The sum of this wiring is then connected to at least one 2 way 12-volt micro sized, electrical plug that has a “+” and “−” (positive and negative) lead for use to power heating device(s) to keep the garments user warm.

9. The method of manufacture of claim 8 wherein, a 12-volt plug is provided for use to power cooling device(s) to keep the garments user cool.

10. The method of manufacture of claim 8 wherein, a 12-volt plug is provided for use to power other electrically powered device(s) such as navigational equipment, computer equipment, cooking utensil(s), CD or DVD equipment, in general, other equipment used to facilitate the survival of the garments user.

11. The method of manufacture of claim 8 wherein, a second 12-volt plug is provided for a connection to a tether electrical cord for connection to other solar powered survival suit(s), such that multiple users may combine the summation of electrical energy.

12. The method of manufacture of claim 1 wherein, the construction of the garment portion of the solar powered survival suit is accomplished by the use of a simple cut out paper pattern for ski jacket with hood and pants, such as those supplied from most fabric stores. Essentially, cutting out the above described material into individual patterned parts, such as the arms, backing, pants, hood, the parts are sewn together using a conventional sewing machine or over-lock machine, when stretch fabric is sought to be employed. The hood may be removed by the use of Velcro for point of attachment.

13. The method of manufacture of claim 12 wherein, the individual pattern may be changed from that of a ski suit, to any basic paper pattern that would form a jacket with hood and pants to that of a simple jacket with hood and pants, used in an urban setting.
